(19) United States
(12) Patent Application Publication
(10) Pub. No.: US 2007/0215661 A1
(43) Pub. Date: Sep. 20, 2007

(54) Utility system for motorized wheelchairs and scooters

(75) Inventors: Scott L. Caplan, Haines City, FL (US); Michael B. Hickland, Brandon, FL (US)

Correspondence Address: DAVID W. PETTIS, JR., PA, 1210 MILLENIUM PARKWAY, SUITE 2010, BRANDON, FL, 33511-0833, US

(73) Assignee: GREGORY J. LIGELIS

(21) Appl. No.: 11/374,910

(22) Filed: Mar. 14, 2006

(51) Int. Cl. A47B 83/02; B60R 7/00; B60R 9/00

(52) U.S. Cl. 224/407; 224/519; 297/135

(57) ABSTRACT

A utility system intended for use with motorized and non-motorized wheelchairs and/or scooters having a hitch receiver mounted thereon by attachment to the hitch receiver, so that one or more auxiliary devices may be operably mounted on the wheelchair or scooter for use by its occupant.

### BACKGROUND OF THE INVENTION

1. Field of the Invention:

The present invention relates to a utility system intended for use with motorized and non-motorized wheelchairs and/or scooters that have a hitch receiver mounted thereon. The utility system of this invention, according to the preferred embodiments described hereinafter, comprises a series of arms and supports that are removably attachable to the hitch receiver and provide for operable attachment of one or more auxiliary devices such as, for example, a tray table, a holder for an oxygen bottle, a basket for holding a variety of articles, a holder for a cane or a walker, or even a rear view mirror.

2. Description of the Prior Art:

Numerous means for attaching auxiliary devices to wheelchairs and scooters are known in the art. For example, it is known to provide means on a wheelchair so that fluid can be administered to the chair's user intravenously while sitting or riding in the chair. It is also known to provide means for attaching a tray or table to chairs and scooters in a fashion so that the tray can be moved to and from an operable position across the lap of a person sitting in the chair or scooter. Constructions are even taught in prior art patents for attaching what might generally be described as a “trailer” behind a wheelchair or scooter so that a variety of articles can be placed on the “trailer” and travel along with the chair.

Particularly with regard to special purpose wheelchairs and scooters of the type typically used by persons with spinal cord injuries, or other neurological impairments, numerous attachments are known. Many of these attachments for special purpose chairs and scooters provide additional support to the user sitting therein. Other attachments may provide means for holding auxiliary devices such as, for example, a laptop computer.

Notwithstanding the variety of prior art devices that are suitable for attaching auxiliary devices to wheelchairs and scooters, virtually all such prior art devices might be termed single use. That is to say, the vast majority of accessory mounts useful with wheelchairs and scooters are constructed and attached to the chair or scooter so that only a single accessory may be mounted. If more than one accessory device is needed, multiple attachments to the chair or scooter are required. This necessarily increases the cost of such systems and, primarily due to the multiplicity of attachments being made, increases the likelihood of a mechanical failure of one or more of those attachments.

It is therefore clear that there remains a need for a utility system used in combination with both motorized and non-motorized wheelchairs and scooters wherein the system may be used to operably mount not only one, but also more than one, auxiliary device. Such a system should be easy to install and remove, should possess reliable mechanical parts, and should permit the attachment of a variety of auxiliary devices to the chair or scooter.

### SUMMARY OF THE INVENTION

According to preferred embodiments described in greater detail below, the utility system of this invention is primarily intended for use in combination with wheelchairs or scooters that have a hitch receiver mounted thereon. The utility system comprises a T-hitch member that is removably attachable to the hitch receiver, and a horizontal arm that is removably attachable to the cross bar of the T-hitch. A vertical receiver is disposed on at least one of the ends of the horizontal arm in substantially transverse relation thereto, and a vertical support is removably attachable to the vertical receiver. Auxiliary devices such as, for example, a tray table may be attached to the vertical support so that a user of the chair or scooter may pivot the tray into a use position across his or her lap, or to a non-use position substantially parallel to one side of the chair or scooter. According to another preferred embodiment, the utility system may be used in combination with an article holder that is removably attachable to the vertical support. For example, and with no intention of limiting the scope of the present invention, the article holder might receive and contain an oxygen bottle for the user of the chair or scooter.

The invention accordingly comprises the features of construction, combinations of elements, and arrangements of parts which will be exemplified in the constructions hereinafter set forth, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is a perspective view of a first preferred embodiment of the utility system mounted on a motorized chair or scooter, with the chair shown in phantom.

FIG. 2 is a perspective view of the embodiment shown in FIG. 1.

FIG. 3 is a partial elevation of the embodiment shown in FIG. 1, illustrating placement of the tray in its use position and, in broken lines, its stored position.

FIG. 4 is a top plan view of the embodiment shown in FIG. 1, with the tray in its use position.

FIG. 5 is a rear elevation of the embodiment shown in FIG. 4.

FIG. 6 is a detailed rear elevation of the support body, the horizontal receiver, and the tray support body of the embodiment shown in FIG. 4.

FIG. 7 is a partial side elevation of the structure shown in FIG. 6.

FIG. 8 is a sectional view of the structure shown in FIG. 7.

FIG. 9 is a partial top plan view of a second preferred embodiment of the utility system.

FIG. 10 is a rear elevation of the embodiment of FIG. 9 showing placement of an oxygen bottle within the article holder in phantom.

Similar reference characters refer to similar parts throughout the several views of the drawings.

### DETAILED DESCRIPTION

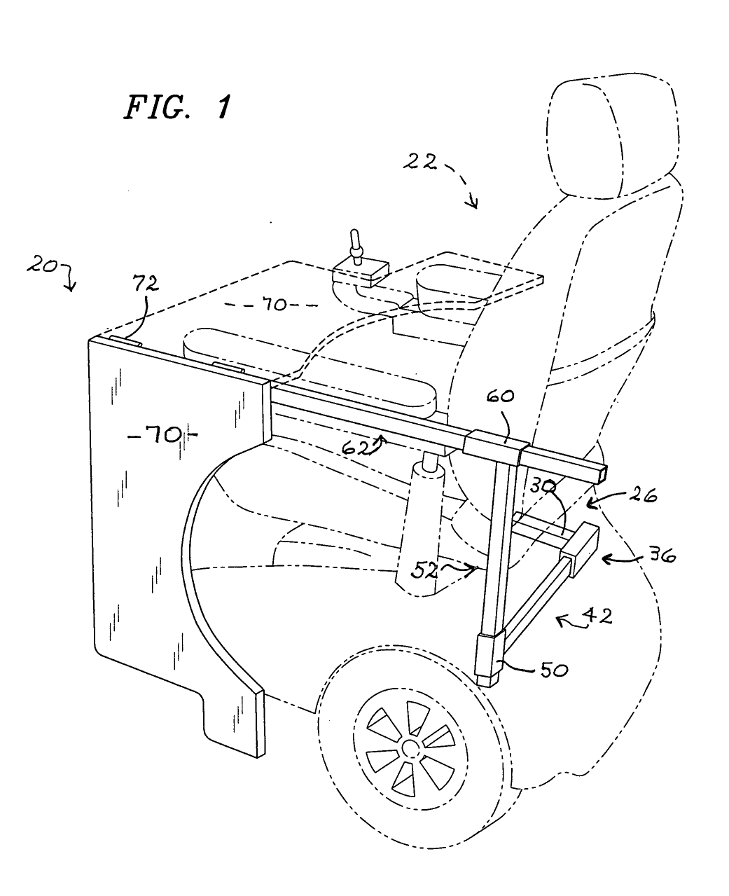

The following detailed description is provided for the purpose of clearly and completely describing the utility system of this invention in preferred embodiments. While the utility system is primarily intended for use in combination with motorized wheelchairs or scooters, it is to be understood that embodiments of the utility system are quite adaptable to non-motorized devices as well. For purposes of illustration only, preferred embodiments are hereinafter described, and illustrated in the view of FIG. 1, as being used in combination with a motorized device.

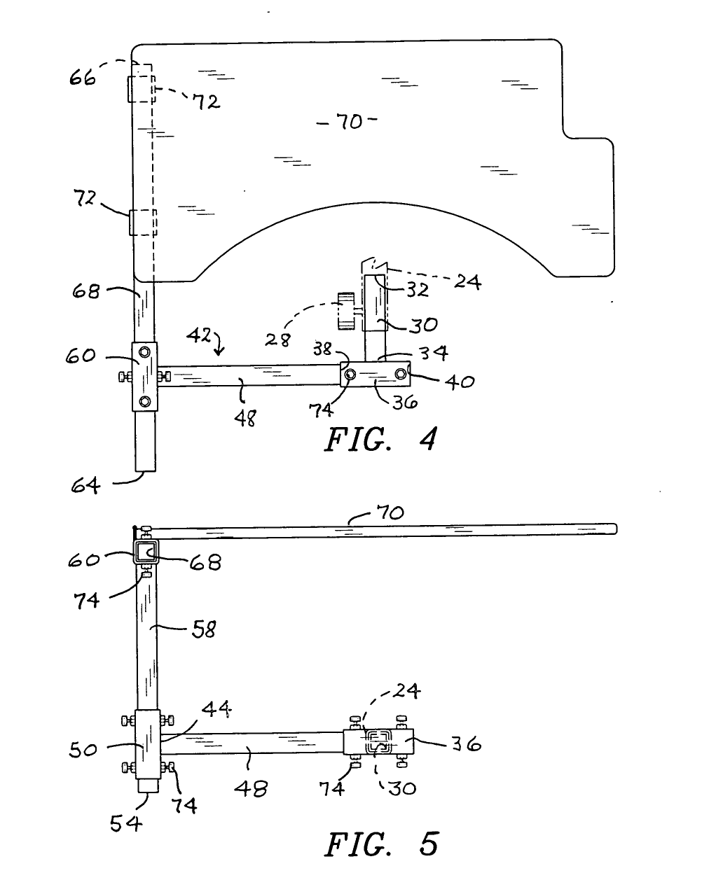

Referring to the view of FIG. 1, a preferred embodiment of the utility system is generally indicated as 20, shown in solid line with the motorized scooter shown in phantom and generally indicated as 22. As shown in phantom in the view of FIG. 4, scooter 22 includes a hitch receiver 24 mounted thereon at the rear of scooter 22.

This embodiment for utility system 20 comprises a T-hitch member 26 that is removably attachable to hitch receiver 24. As best seen in the view of FIG. 4, hitch receiver 24 includes a screw member 28 for retaining T-hitch member 26 within the hitch receiver 24. It is to be understood that different models of scooters 22 may include other means for receiving and holding T-hitch member 26 within hitch receiver 24.

T-hitch member 26 comprises a hitch leg 30 having a first leg end 32 and a second leg end 34. As shown in the drawings, first leg end 32 is received within hitch receiver 24. A hitch cross bar 36 is attached in substantially transverse relation to hitch leg 30 at second leg end 34. Hitch cross bar 36 is a hollow tube and includes a first tube end 38 and a second tube end 40.

Utility system 20 further comprises a horizontal arm, generally indicated as 42. Horizontal arm 42 comprises of first arm end 44, a second arm end 46, and arm body 48 extending there between. Arm body 48 is dimensioned and configured to be received within tube body 41. A vertical receiver 50 is shown as being disposed on first arm end 44 in substantially transverse relation to the longitudinal dimension defined by arm body 48.

A vertical support, generally indicated as 52, is removably attachable to vertical receiver 50. Vertical support 52 includes a first support end 54, a second support end 56, and a support body 58 extending there between. As shown in the drawings, first support end 54 is received in vertical receiver 50, and is adjustable, up and down therethrough. Of course, this means that support body 58 is dimensioned and configured for sliding engagement through vertical receiver 50.

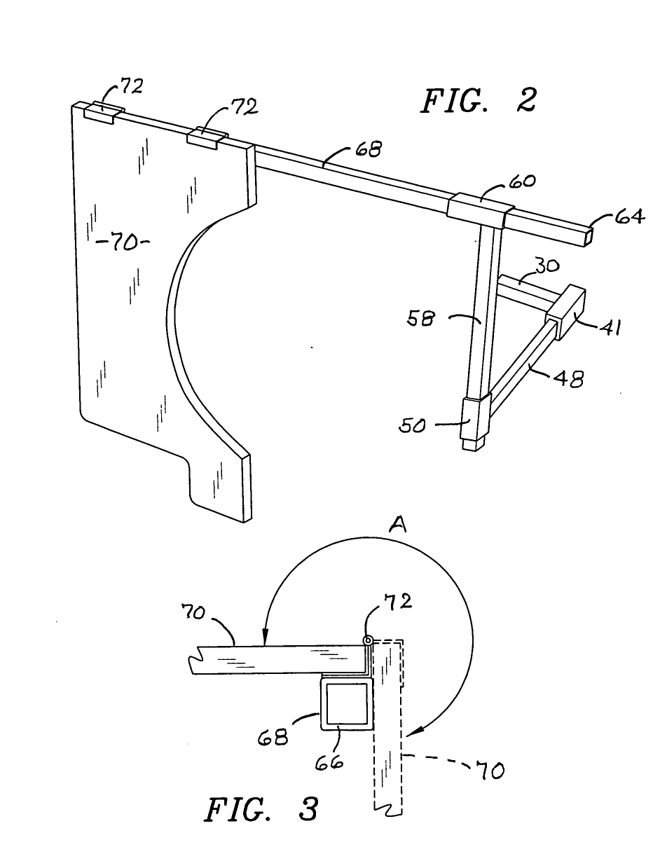

This embodiment of utility system 20 further comprises a horizontal receiver 60 disposed on second support end 56 in substantially parallel relation to hitch leg 30. This embodiment further comprises a tray support generally indicated as 62 having a first tray support end 64, a second tray support end 66, and a tray support body 68 extending there between. Tray support body 68 is dimensioned and configured to be received within horizontal receiver 60. Finally, a tray 70 is pivotally attached to tray support body 68 substantially adjacent second tray support end 66 as by hinges 72. The views of FIGS. 1 and 2 illustrate tray 70 disposed in a non-use, or stored, position, while the views of FIGS. 3, 4 and 5 illustrate the pivoting motion of tray 70 to its use position. This pivoting motion is indicated by arrow A in the view of FIG. 3.

Thus, this embodiment for utility system 20 provides for the attachment of a tray 70 to scooter 22 so that tray 70 may be disposed in both a use position across the lap of a user seated in scooter 22, and in a stored position adjacent one side of scooter 22. The position of tray 70 with respect to a user seated in scooter 22 may be adjusted, both fore and aft by adjusting tray support body 68 back and forth through horizontal receiver 60. The relative height of tray 70 may likewise be adjusted by sliding support body 58 of vertical support 52 up and down within vertical receiver 50.

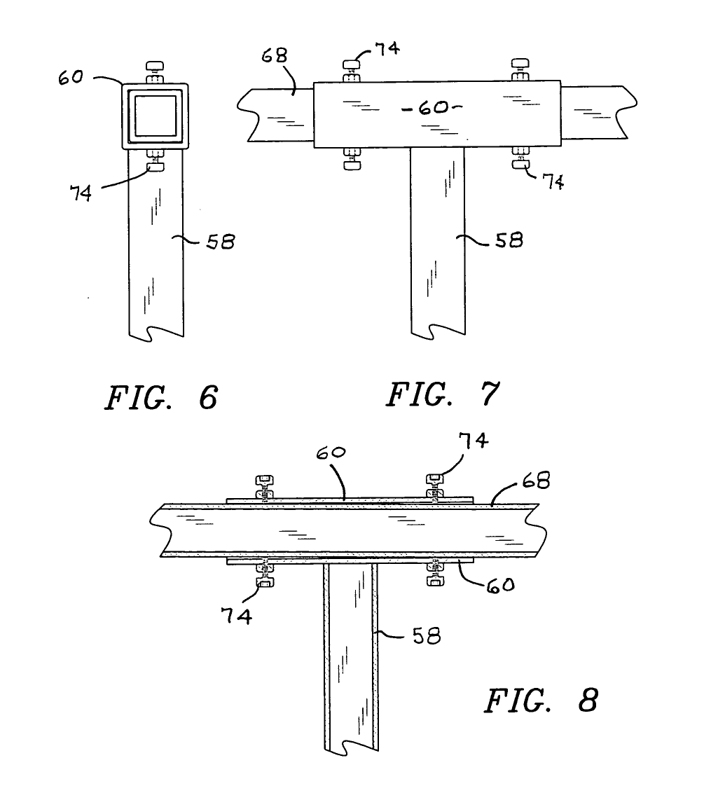

Referring to the views of FIGS. 4-8, this embodiment of utility system 20 is shown as utilizing a plurality of thumb screws 74 for the purpose of removably retaining arm body 48 within tube body 41, support body 58 within vertical receiver 50, and tray support body 68 within horizontal receiver 60. It is to be understood that the scope of the present invention is not to be limited to the illustrated thumb screws 74. Alternative devices for accomplishing the same purpose such as, for example only, cotter pins, bolts and nuts, or spring-loaded detents might be used. Though not recommended, it is even contemplated that the various elements could be permanently fixed to each other as by welding, for example.

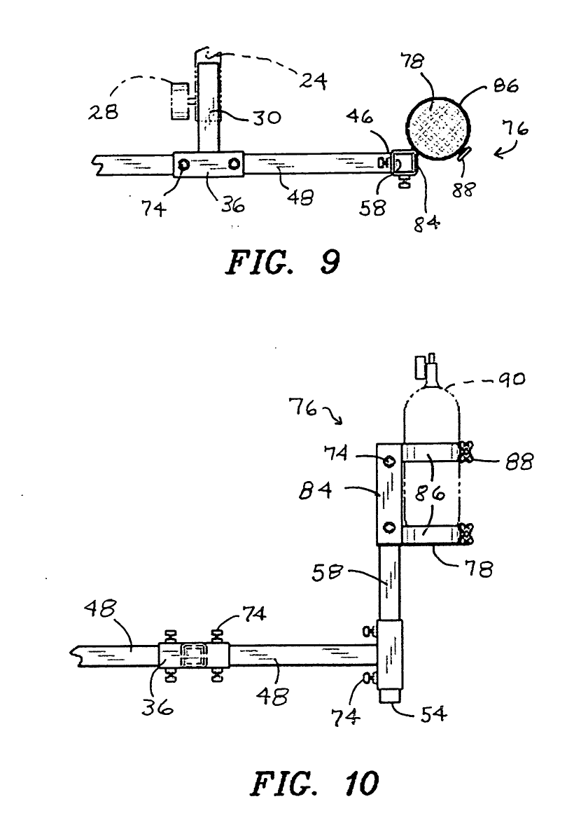

Turning to the views of FIGS. 9 and 10, a second embodiment for a utility system 20 is illustrated. According to this second embodiment, arm body 48 of horizontal arm 42 extends through hitch cross bar 36 and a vertical receiver 50 is disposed on second arm end 46. This embodiment further comprises an article holder, generally indicated as 76, removably attachable to the vertical receiver 50 disposed at second arm end 46. Article holder 76 comprises a base member 78, a holder receiver member having a first receiver member end 80, a second receiver member end 82, and a hollow receiver body 84 extending there between. As seen in the views of FIGS. 9 and 10, hollow receiver body 84 is disposed on the vertical support body 58 attached to vertical receiver 50. Article holder 76 further comprises retaining means defined by a pair of bands 86 attached to hollow receiver body 84 in spaced apart, vertical relation to each other for releasably engaging an article placed therein such as, for example, the oxygen bottle 90 shown in phantom in the view of FIG. 10. Vertical positioning of article holder 76 may be adjusted either by repositioning hollow receiver body 84 with respect to support body 58, or repositioning support body 58 with respect to its vertical receiver 50. The views of FIGS. 9 and 10 illustrate the use of additional thumb screws 74 for adjusting and retaining those movable elements. The views of FIGS. 9 and 10 further disclose the use of screw-type fasteners 88 for securing bands 86 around oxygen bottle 90.

In this detailed description of preferred embodiments, and in the illustrative drawings, the various elements of utility system 20 are shown as defining substantially square cross-sections. It is to understood that the scope of the present invention is not thereby limited. The preferred square cross-section has been chosen for ease of manufacture and operation. However, virtually any cross-sectional shape could be used so long as cooperating elements were similarly formed.

According to the preferred construction for utility system 20, the structural elements are preferably formed from a strong, lightweight material such as, for example only, aluminum. Other materials are intended to be included within the scope of the present invention, and it is even contemplated that the various elements could be formed from non-metal synthetic materials. Though not desired as a preferred embodiment, utility system 20 could actually be formed from wood. In any event, the material chosen for the various elements is not a limiting factor to the scope of the present invention, and a combination of two or more such elements might actually be used.

It will thus be seen that the object set forth above, among those made apparent from the preceding description, are efficiently attained and, since certain changes may be made in the above constructions without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

Now that the invention has been described,

What is claimed is:

1. A utility system to be used in combination with a wheelchair or scooter having a hitch receiver mounted thereon, said utility system comprising: a T-hitch member comprising a hitch leg having a first leg end and a second leg end, said first leg end being removably attachable to the hitch receiver, and a hitch crossbar attached in substantially transverse relation to said hitch leg at said second leg end, said hitch crossbar comprising a hollow tube having a first tube end, a second tube end, and a tube body extending between said first and second tube ends; a horizontal arm having a first arm end, a second arm end, and an arm body extending therebetween, said arm body being removably attachable to said hitch crossbar by inserting said arm body into said hollow tube, and a vertical receiver disposed on one of said first and second arm ends in substantially transverse relation to said arm body; and a vertical support having a first support end, a second support end, and a support body extending therebetween, said first support end being removably attachable to said vertical receiver.

2. A utility system as in claim 1 wherein said vertical receiver is disposed on said first arm end; said utility system further comprising a horizontal receiver disposed on said second support end in substantially parallel relation to said hitch leg; a tray support having a first tray support end, a second tray support end, and a tray support body extending therebetween and having an axis defined by a line extending between said first and second tray support ends, said tray support body being removably attachable to said horizontal receiver, and a tray being pivotally attached to said tray support body substantially adjacent said second tray support end for pivotal movement around said axis of said tray support body.

3. A utility system as in claim 1 wherein said vertical receiver is disposed on said second arm end, said utility system further comprising an article holder removably attachable to said second support end, said article holder comprising a base member, a holder receiver member having a first end, a second end, and a hollow receiver body defined by the distance between said first end and said second end, said first end being attached to said base member in substantially normal relation to a plane defined by said base member, and said second end extending upwardly therefrom, said article holder further comprising retaining means attached to a segment of said receiver member whereby an article placed on said base member may be held thereon against said holder receiver by said retaining member.

4. A utility system as in claim 3 wherein said retaining means comprises a pair of adjustable bands attached in spaced apart relation on said holder receiver, each one of said bands defining a plane that is substantially parallel to the plane defined by said base member.

5. A utility system to be used in combination with a wheelchair or scooter having a hitch receiver mounted thereon, said utility system comprising: a T-hitch member comprising a hitch leg having a first leg end and a second leg end, said first leg end being removably attachable to the hitch receiver, and a hitch crossbar attached in substantially transverse relation to said hitch leg at said second leg end, said hitch crossbar comprising a hollow tube having a first tube end, a second tube end, and a tube body extending between said first and second tube ends; a horizontal arm having a first arm end, a second arm end, and an arm body extending therebetween, said arm body being removably attachable to said hitch crossbar by inserting said arm body into said hollow tube, and a first vertical receiver disposed on said first arm end and a second vertical receiver disposed on said second arm end, both of said first and second vertical receivers being in substantially transverse relation to said arm body; and a pair of vertical supports each one of said pair having a first support end, a second support end, and a support body extending therebetween, one of said first support ends being removably attachable to said first vertical receiver and the other of said first support ends being removably attachable to said second vertical receiver.

6. A utility system as in claim 5 further comprising horizontal receiver disposed on said second support end of said vertical support attached to said first vertical receiver in substantially parallel relation to said hitch leg; a tray support having a first tray support end, a second tray support end, and a tray support body extending therebetween and having an axis defined by a line extending between said first and second tray support ends, said tray support body being removably attachable to said horizontal receiver, and a tray being pivotally attached to said tray support body substantially adjacent said second tray support end for pivotal movement around said axis of said tray support body, and further comprising an article holder removably attachable to said second support end of said vertical support attached to said to said second vertical receiver, said article holder comprising a base member, a holder receiver member having a first end, a second end, and a hollow receiver body defined by the distance between said first end and said second end, said first end being attached to said base member in substantially normal relation to a plane defined by said base member, and said second end extending upwardly therefrom, said article holder further comprising retaining means attached to a segment of said receiver member whereby an article placed on said base member may be held thereon against said holder receiver by said retaining member.
